(19) United States
(12) Patent Application Publication
(10) Pub. No.: US 2026/0309255 A1
(43) Pub. Date: Oct. 8, 2026

(54) LINER HOSE WITH INTEGRATED SENSOR SYSTEM

(71) Applicant: RELINEEUROPE GMBH, Rohrbach (DE)

(72) Inventor: Rainer WENDEL, Rohrbach (DE)

(21) Appl. No.: 19/482,696

(22) PCT Filed: May 8, 2024
(86) PCT No.: PCT/DE2024/100417

§ 371 Date: Nov. 7, 2025

(30) Foreign Application Priority Data
May 8, 2023 (DE) 102023001860.0

(51) Int. Cl. F16L 11/127; F16L 11/08

(52) U.S. Cl. CPC F16L 11/127; F16L 11/08; F16L 2201/30

(57) ABSTRACT

The present invention relates to a liner hose comprising an inner film, a resin-impregnated, curable layer, and an outer film, wherein a measuring device is incorporated between the inner film and the curable layer and/or between the curable layer and the outer film, and wherein the measuring device comprises fibers and/or threads which, in the uncured state, have been incorporated into the liner hose in a horizontal and/or vertical direction by sewing on, weaving in, gluing, and/or inserting, and wherein the fibers and/or threads are optical conductive fibers and/or threads and/or electrically conductive threads and/or fibers, and wherein the measuring device is designed and arranged to measure the conductivity of the material located between the fibers and/or threads.

The present invention relates to a liner hose with integrated sensor technology for the detection of damage.

Methods for the rehabilitation of pipeline systems, in which, for example, liquid or gaseous media are transported, are known in the prior art and have been described many times.

For example, methods are known in which the sections of the pipeline system that have a defect or damage are replaced by new sections. However, this is laborious and also not always possible.

Furthermore, methods are known in the prior art in which, for the rehabilitation of pipeline systems, for example of sewers and similar pipe systems, a flexible, curable layer impregnated with a curable resin, which serves as a liner hose, also referred to as a liner, is introduced into the pipeline system. After the introduction, the liner hose is expanded so that it closely adapts to the inner wall of the pipeline system. Subsequently, the resin is cured.

The production of such a liner hose is described, for example, in WO 95/04646. Such a liner hose usually has an outer protective film that is impermeable to light, an inner film that is permeable to electromagnetic radiation at least for certain wavelength ranges, and a curable layer impregnated with a resin, which is arranged between the inner film and the outer film.

The outer film hose is intended to prevent the resin used for the impregnation from escaping from the curable layer and from entering the environment. This requires good tightness and adhesion of the outer film hose to the resin-impregnated curable layer.

From WO 00/73692 A1 a liner hose is known which comprises an inner film hose, a fiber tape impregnated with a resin as a curable layer, and an outer hose which is laminated on its inner side with a fiber fleece.

From WO 00/73692 A1 a liner hose is known which comprises an inner film hose, a fiber tape impregnated with a resin as a curable layer, and an outer hose which is laminated on its inner side with a fiber fleece.

These unsaturated polyesters or vinyl esters can be cured thermally (usually by means of peroxide catalysts) or by means of radiation, e.g. by UV light with photoinitiators, as described for example in EP-A 23623. So-called combination cures with a peroxide initiator used for the thermal curing in combination with photoinitiators are also possible and have proven to be particularly advantageous in the case of large wall thicknesses of the liner hoses. A method for such a so-called combination curing is described, for example, in EP-A 1262708. Unsaturated polyester or vinyl ester resins are subject to shrinkage during curing, which may impair the stability of the rehabilitated pipeline system in subsequent operation. Epoxy ester resins, on the other hand, exhibit better dimensional stability during curing after insertion.

The inner hose itself is also wound around a winding mandrel to simplify production. Alternatively, WO 95/04646 discloses, for example, that a prefabricated inner film hose can be inflated and can itself serve as a winding mandrel. Such a prefabricated inner film hose is produced from a film strip, the film edges of which are connected to one another by welding or gluing in order to form the inner film hose.

Before curing, the liner hoses are inserted into the pipeline systems to be rehabilitated and inflated by means of a fluid, generally compressed air. For inflating the liner hose, according to the prior art, one open end of the liner hose is acted upon with compressed air and the opposite open end of the liner hose is closed with a sealing device, a so-called packer. This sealing device comprises a hollow cylinder and a covering element with which the hollow cylinder can be closed.

A curing device, which has a radiation source, is introduced into the liner hose in order to cure the latter, and is guided through the liner hose in order, by means of the radiation energy, to activate or carry out the curing of the curable layers of the liner hose.

In this context, complete curing of the liner hoses is of great importance, i.e., a specific amount of radiation energy must be introduced into the liner hose at every point thereof. The amount of radiation energy depends on the power output of the radiation sources as well as on the speed at which these are guided through the liner hose.

DE19817413 A1 discloses a method for controlling the speed of curing of a liner hose. In this method, one or more UV light sources are guided through the pipe by means of a centrally guided pulling cable, whereby the resin of the curable layer of the liner hose is cured. The control of the speed at which the light sources are pulled is carried out as a function of the temperature generated on the inner surface of the hose by the exothermic curing reaction.

In the region of the light sources, a number of IR sensors are carried along, which are aligned at the same angle toward a fictitious line running parallel to the pulling cable on the inner surface of the hose. On this line, specific measuring points are defined, wherein, during the passage of the sensors past the measuring points, the temperature at each measuring point is measured by the sensors.

It is therefore generally known from the prior art to determine sensor values on the inner side of the liner hose on the basis of discontinuous measuring points in order to control the speed of advancement of a curing device.

Methods are also known from the prior art in which the temperature inside the liner hose itself is measured by introducing sensor tapes. EP 2037246 A1 describes a method for monitoring the temperature of a liner hose in a pipe or sewer system, which can be carried out over a long period of time, wherein measurements performed once in time or repeated at any desired time intervals are possible.

As explained, the temperature and its measurement are of great importance for the proper curing and for documenting the curing, and methods relating thereto are described in the prior art.

However, it would be desirable to measure additional states of a liner hose over a long period of time.

In this connection, it would be particularly desirable to be able to document damage to the liner hose, deformations, and the like. This is particularly advantageous when liner hoses are used in large-scale industrial installations which require a high level of process reliability. By specifically detecting condition values, for example, maintenance and inspection cycles could be extended and documentation and safety requirements could be met.

The object of the present invention is therefore to provide a liner hose which, by means of integrated sensor technology, is capable of supplying measurement values relating to its condition.

This object is achieved in particular by a liner hose having an inner film, a resin-impregnated, curable layer, and an outer film, wherein a measuring device is incorporated between the inner film and the curable layer and/or between the curable layer and the outer film, and wherein the measuring device comprises fibers and/or threads which, in the uncured state, have been incorporated into the liner hose in horizontal and/or vertical direction by sewing on, weaving in, gluing, and/or inserting, and wherein the fibers and/or threads are optical conductive fibers and/or threads and/or electrically conductive threads and/or fibers, and wherein the measuring device is designed and arranged to measure the conductivity of the material located between the fibers and/or threads.

The surprising finding of the present invention lies in the fact that, by incorporating fibers and/or threads into the liner hose, a multitude of relevant measurement values can be obtained.

If, for example, electrically conductive fibers and/or threads are incorporated into the liner hose, their changing conductivity can be measured directly and/or a resistance from one fiber and/or one thread to another fiber and/or another thread can be measured. From the change in the conductivity or resistance values, conclusions can in turn be drawn regarding desired properties of the liner hose to be measured.

If, for example, a thread is arranged on the side of the inner film of the liner hose facing the curable layer, and if, over time, the inner film becomes damaged, the moisture, which usually penetrates at least temporarily, has an influence on the measurement values, and damage can be detected.

If several fibers and/or threads are arranged in different radial distances within the liner hose, it is also possible, for example, to determine the penetration depth of the moisture.

A further example is the initial curing process. If fibers and/or threads are arranged in or on the curable layer, which is initially not yet cured and thus moist, these exhibit different resistance or conductivity values than when the curable layer is cured and thus dry.

A further example consists of bulges and deformations of sections of liner hoses. As a result of the deformation, it may occur that the fibers and/or threads are compressed or stretched and/or change their relative distance from one another. All of this can be detected by measurement.

The above-mentioned embodiments of the fibers and/or threads with measurement of the resistance values or conductivity values are obviously to be understood as being purely exemplary; other measurement values can also be used. In particular, in the case of optical fibers, a change in the wavelength in the fiber, when transmitting and receiving light and pulses between fibers, can also, for example, depend on the water content in the measurement area.

Furthermore, it may be advantageous that a fleece is included, wherein the fleece is arranged between the inner film and the curable layer, and wherein the measuring device is arranged between the inner film and the fleece and/or between the fleece and the curable layer.

In the present case, the invention claims liner hoses. The individual layers are in each case to be understood in principle as covering at least a circular segment of the cross-section of the liner hose, but as a rule they themselves form a complete hose layer.

As already explained, it may be advantageous in this case that a fleece layer is included and that the measuring device according to the invention is in operative connection with this fleece layer. In this connection, according to one embodiment, the measuring device may be woven directly into the fleece or sewn onto the fleece.

A styrene barrier may also be provided according to one embodiment, which is arranged between the curable layer and the outer film, and wherein the measuring device is arranged between the inner film and the styrene barrier, between the fleece and the styrene barrier, and/or between the curable layer and the styrene barrier.

Finally, it may be provided that the measuring device is arranged in the curable layer.

According to the invention, there are different planes which are radially spaced from one another, in or on which the measuring device according to the invention can be arranged. It may in particular be provided that the measuring device is simultaneously arranged in different planes, wherein both horizontal measurements, that is to say at the same radial distance around the liner hose relative to a fictitious center of the liner hose, and vertical measurements, that is to say in the direction from the inside to the outside, can be carried out.

Such measurements can be carried out either in that the fibers and/or threads according to the invention themselves are incorporated horizontally and/or vertically, or in that measurements take place between different fibers and/or threads.

It may in particular be provided that the fibers and/or threads of the measuring device are formed in the form of a fleece, mesh, fabric, and/or laid scrim.

Fibers and/or threads can in each case be used individually as a single fiber and/or thread according to the invention. However, it may also be provided that these are formed in the form of a fleece, mesh, fabric, and/or laid scrim, in which case not only the individual fiber and/or the individual thread, but entire groups of fibers and/or threads can be incorporated.

It may in particular also be provided that the fibers and/or threads are incorporated in-situ in the manufacturing process of the curable layer and/or of the fleece.

According to the invention, it may be provided that the fibers and/or threads are sewn on, glued on, laminated, or otherwise incorporated when producing the liner hose. According to one embodiment, it may also be particularly advantageous if these are worked in-situ into the curable layer and/or into the fleece during the manufacturing process. In this case, the fibers and/or threads are already securely located in the correct position and no longer need to be fixed subsequently.

It may also be provided that the measuring device measures a resistance, a conductivity (capacitive, resistive, inductive), and/or a phase shift of the individual fibers and/or threads, of groups of fibers and/or threads, and/or between fibers and/or threads and/or groups of fibers and/or threads, over the length of the liner hose or in sections.

As already explained, according to the invention both capacitive and optical measurements are provided in order to obtain measurement values by means of the fibers and/or threads.

It may in particular be advantageous that the measuring device is designed and configured to determine, from the measured data, the surface quality of the individual layers of the liner hose and/or their thickness and/or their geometry.

Furthermore, according to one embodiment, it is preferred that the measuring device comprises measuring sensors which can be brought into contact with individual fibers and/or threads, a plurality of fibers and/or threads, and/or groups of fibers and/or threads, in order to measure the measurement values.

It is preferred that the measuring sensors introduce an electrical or optical pulse at one or more input measuring sensors and receive it at one or more output measuring sensors, wherein the input measuring sensors and output measuring sensors are arranged at the beginning and at the end of the liner hose and, in particular, also sectionally over the length of the liner hose.

According to the invention, different measurement methods can be used. According to one embodiment, measuring sensors are arranged at the respective ends of the liner hoses, and a measurement is carried out over the entire length of the liner hose.

However, it may also be provided that the liner hose is divided into segments by measuring sensors, wherein measurements take place in each case from segment to segment.

It may also be provided that measurements are carried out between the individual fibers and/or threads, so that complex geometries can be evaluated in horizontal and vertical directions.

The invention also provides a system comprising a liner hose according to the invention and a data processing device, wherein the measurement values of the measuring device are stored in the data processing device.

It may be provided that the data processing device stores the data at the location of the liner hose and/or on a server.

The invention also provides a method for detecting measurement values of a liner hose according to the invention, wherein the measuring device sends a measurement signal to fibers and/or threads included by the measuring device and receives a response, wherein, from the received response, a surface quality, a deformation, a crack, and/or further material parameters of the individual layers of the liner hose are calculated.

It may in particular be provided that the measurement signal is an electrical and/or optical pulse, in particular a modulated pulse, a continuous application of a voltage, and/or a continuous optical signal.

Further features and advantages of the invention will become apparent from the following description, in which exemplary embodiments of the invention are explained by way of a schematic drawing, without thereby limiting the invention.

In the drawings:

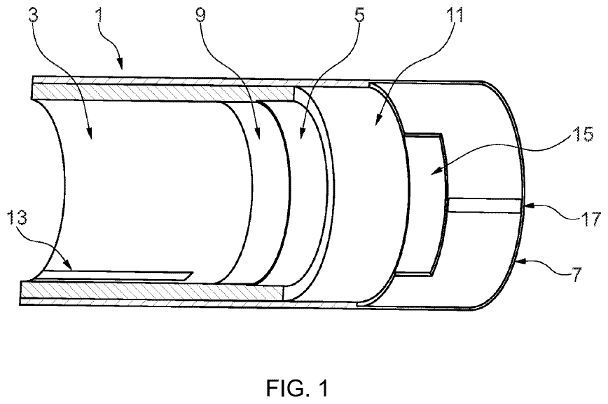

FIG. 1: a schematic sectional view of a liner hose according to the invention.

In FIG. 1, a liner hose 1 is shown having an inner film 3, a curable layer 5, and an outer film 7. On the inner side of the inner film 3 facing the curable layer 5, a fleece 9 is arranged, and on the side of the curable layer 5 facing the outer film 7, a styrene barrier 11 is arranged.

Furthermore, the exemplary liner hose 1 comprises an internal pulling tape 13, a longitudinal tape 15, and a measuring tape 17.

The fibers and/or tapes of the measuring device according to the invention can, according to the invention, be arranged between each of the layers described or be integrated in-situ into the curable layer 5 or the fleece 9. By means of measuring sensors, not shown, measurement signals can then be fed in and received.

The features of the invention disclosed in the foregoing description and in the claims may be essential for the realization of the invention, both individually and in any arbitrary combination, in its various embodiments.

1. Liner hose comprising an inner film, a resin-impregnated, curable layer, and an outer film,
wherein a measuring device is incorporated between the inner film and the curable layer and/or between the curable layer and the outer film,
and wherein the measuring device comprises fibers and/or threads which, in the uncured state, have been incorporated into the liner hose in a horizontal and/or vertical direction by sewing on, weaving in, gluing, and/or inserting,
and wherein the fibers and/or threads are optical conductive fibers and/or threads and/or electrically conductive threads and/or fibers,
and wherein the measuring device is designed and arranged to measure the conductivity of the material located between the fibers and/or threads.

2. Liner hose according to claim 1, further comprising a fleece, wherein the fleece is arranged between the inner film and the curable layer, and wherein the measuring device is arranged between the inner film and the fleece and/or between the fleece and the curable layer.

3. Liner hose according to claim 1, further comprising a styrene barrier, which is arranged between the curable layer and the outer film, and wherein the measuring device is arranged between the inner film and the styrene barrier, between the fleece and the styrene barrier, and/or between the curable layer and the styrene barrier.

4. Liner hose according to claim 1, characterized in that the measuring device is arranged in the curable layer.

5. Liner hose according to claim 1, characterized in that the fibers and/or threads of the measuring device are formed in the form of a fleece, mesh, fabric, and/or laid scrim.

6. Liner hose according to claim 1, characterized in that the fibers and/or threads are incorporated in-situ in the manufacturing process of the curable layer and/or of the fleece.

7. Liner hose according to claim 1, characterized in that the measuring device measures a resistance, a conductivity (capacitive, resistive, inductive), and/or a phase shift of the individual fibers and/or threads, of groups of fibers and/or threads, and/or between fibers and/or threads and/or groups of fibers and/or threads, over the length of the liner hose or in sections.

8. Liner hose according to claim 1, characterized in that the measuring device is designed and configured to determine, from the measured data, the surface quality of the individual layers of the liner hose and/or their thickness and/or their geometry.

9. Liner hose according to claim 1, characterized in that the measuring device comprises measuring sensors which can be brought into contact with individual fibers and/or threads, a plurality of fibers and/or threads, and/or groups of fibers and/or threads, in order to measure the measurement values.

10. Liner hose according to claim 9, characterized in that the measuring sensors introduce an electrical or optical pulse at one or more input measuring sensors and receive it at one or more output measuring sensors, wherein the input measuring sensors and the output measuring sensors are arranged at the beginning and at the end of the liner hose and, in particular, also sectionally over the length of the liner hose.

11. System comprising a liner hose according to claim 1 and a data processing device, wherein the measurement values of the measuring device are stored in the data processing device.

12. System according to claim 11, characterized in that the data processing device stores the data at the location of the liner hose and/or on a server.

13. Method for detecting measurement values of a liner hose according to claim 1, wherein the measuring device sends a measurement signal to fibers and/or threads included by the measuring device and receives a response, wherein, from the received response, a surface quality, a deformation, a crack, and/or further material parameters of the individual layers of the liner hose are calculated.

14. Method according to claim 13, wherein the measurement signal is an electrical and/or optical pulse, in particular a modulated pulse, a continuous application of a voltage, and/or a continuous optical signal.
